(19) United States
(12) Patent Application Publication
(10) Pub. No.: US 2011/0135323 A1
(43) Pub. Date: Jun. 9, 2011

(54) IMAGE FORMING APPARATUS AND COMPUTER-READABLE STORAGE MEDIUM

(75) Inventor: Masaichi Sawada, Tokyo (JP)

(73) Assignee: RICOH COMPANY, LTD., Tokyo (JP)

(21) Appl. No.: 12/955,966

(22) Filed: Nov. 30, 2010

(30) Foreign Application Priority Data
Dec. 4, 2009 (JP) 2009-276216

(51) Int. Cl. G03G 15/00

(52) U.S. Cl. 399/16

(57) ABSTRACT

An image forming apparatus includes a measuring part to measure an area in which a recording agent is to be adhered on a recording medium, for each of segmented regions on the recording medium, a computing part to compute an accumulated area by accumulating the measured area for each segmented region with respect to plural recording media, and a storing part to store the computed accumulated area. A rotating part rotates an image to be formed on the recording medium using the recording agent if the accumulated value in the storing part exceeds a threshold value, and an image forming part forms the rotated image on the recording medium.

### CROSS-REFERENCE TO RELATED APPLICATIONS

This application claims the benefit of a Japanese Patent Application No. 2009-276216 filed on Dec. 4, 2009, in the Japanese Patent Office, the disclosure of which is hereby incorporated by reference.

### BACKGROUND OF THE INVENTION

1. Field of the Invention

The present invention generally relates to image forming apparatuses that form images on a recording medium using a recording agent, and to computer-readable storage medium that stores a program which, when executed by a computer, causes the computer to perform a process of the image forming apparatus.

2. Description of the Related Art

Conventionally, wearout parts, such as photoconductive drums, intermediate transfer belts, and pressing rollers, used in printing apparatuses or copying apparatuses are replaced when a number of prints or copies that are formed in one apparatus reaches a predetermined reference number determined by the manufacturer of the apparatus. However, the wear of the wearout part progresses proportionally to the area of paper adhered with a recording agent, such as toner or ink, and not directly proportionally to the number of prints or copies made. For this reason, if a wearout part is replaced when the number of prints or copies made reaches the predetermined reference number, the wearout part may not be worn out or, may already be excessively worn out. Hence, a technique has been proposed to measure a ratio of an area adhered with the recording agent with respect to a region on the paper to be subjected to the recording, and to compute a number of prints or copies that may be made before the wearout part is replaced, based on the measured ratio and a reference ratio determined by the manufacturer. This proposed technique may provide a time when the wearout part is to be replaced.

For example, a Japanese Laid-Open Patent Publication No. 11-99692 proposes a technique to provide a time when the wearout part is to be replaced. In the image forming apparatus which recommends replacement of a cleaning roller after making 10000 prints at a black recording ratio of 5% as a reference, for example, the black recording ratio is 2 times the reference ratio if the measured black recording ratio on the print is 10%. Hence, in this case, a counted value of a counter which counts the number of prints is increased by 2. If the measured black recording ratio on the print is 30%, the counted value of the counter is increased by 6. In other words, a value obtained by dividing the measured black recording ratio by the reference ratio is added to the counted value of the counter. A display urging replacement of the cleaning roller is made on an operation panel of the image forming apparatus when the counted value of the counter reaches 10000.

However, an image quality of the print or copy deteriorates not only when the entire wearout part wears out but also when the wearout part partially wears out. When the image recording is made in a predetermined area of the paper for a relatively large number of prints or copies, the wear of the wearout part becomes considerable for a specific part of the wearout part. As a result, the print or copy may have an unacceptable image quality before the number of prints or copies made reaches the predetermined reference number.

Next, a description will be given of the concentration of the image recording to a predetermined area of each paper, in relation to an image ratio. The image ratio refers to a ratio of an area of the paper adhered with ink with respect to the entire area of the paper. FIG. 1 is a diagram for explaining the image ratio. FIG. 1 illustrates an example in which an image of a letter “A” is printed on an A4-size paper. It is assumed for the sake of convenience that the image is printed at 600 dpi, and ink amounting to approximately 34,800,000 dots may be adhered on the A4-size paper. Ink amounting to approximately 1,740,000 dots may adhere on the A4-size paper when the letter “A” is printed. In this state, the image ratio of the A4-size paper is (1,740,000/34,800,000)×100=5%.

FIG. 2 is a perspective view illustrating a state where a pressing roller and a fixing belt are used to fix ink on the paper. Both a pressing roller 14 and a fixing belt 131 are wearout parts. In addition, portions of the pressing roller 13 and the fixing belt 131 where the ink adheres are indicated by hatchings. If the ink adhesion is concentrated at predetermined portions of the pressing roller 14 and the fixing belt 131, the image ratio in a left region 1 becomes 50% even though the image ratio of the document as a whole is 25%, for example.

In this case, the wear of the wearout parts at portions making contact with the region 1 is considerable compared to other portions of the wearout parts. As a result, the print that is made may have an unacceptable image quality before the number of prints made reaches the predetermined reference number, because of the wear of the wearout parts concentrated at the portions making contact with the region 1. On the other hand, portions of the wearout parts making contact with an adjacent region 2 may not be worn, and the wearout parts may still be usable even when the number of prints made reaches the predetermined reference number. However, the wearout parts would need to be replaced because the portions of the wearout parts making contact with the region 1 will be worn out considerably by the time when the number of prints made reaches the predetermined reference number.

### SUMMARY OF THE INVENTION

Accordingly, it is a general object in one embodiment of the present invention to provide a novel and useful image forming apparatus and computer-readable storage medium, in which the problem described above may be suppressed.

Another and more specific object in one embodiment of the present invention is to provide an image forming apparatus and a computer-readable storage medium, which distribute wear of a wearout part in order to extend a serviceable life or replacement timing of the wear out part.

According to one aspect in one embodiment of the present invention, there is provided an image forming apparatus comprising a measuring part configured to measure an area in which a recording agent is to be adhered on a recording medium, for each of segmented regions on the recording medium; a computing part configured to compute an accumulated area by accumulating the area measured by the measuring part for each of the segmented regions with respect to a plurality of recording media; a storing part configured to store the accumulated area computed by the computing part; a rotating part configured to rotate an image to be formed on the recording medium using the recording agent if the accumulated value stored in the storing part exceeds a threshold value; and an image forming part configured to form on the recording medium the image that is rotated by the rotating part.

According to one aspect in one embodiment of the present invention, there is provided an image forming apparatus comprising a measuring part configured to measure an area in which a recording agent is to be adhered on a recording medium, for each of segmented regions on the recording medium; a first computing part configured to compute an accumulated area by accumulating the area measured by the measuring part for each of the segmented regions with respect to a plurality of recording media; a second computing part configured to compute a total accumulated area by accumulating the area of a predetermined segmented region and the area of a segmented region positioned symmetrically thereto with respect to a line segment extending in a sub scan direction, for the area measured by the measuring part for each of the segmented regions; a storing part configured to store the total accumulated area computed by the second computing part for each of the segmented regions; a rotating part configured to rotate an image to be formed on the recording medium using the recording agent if the total accumulated value stored in the storing part exceeds a threshold value; and an image forming part configured to form on the recording medium the image that is rotated by the rotating part by scanning in a main scan direction and the sub scan direction perpendicular to the main scan direction.

According to one aspect in one embodiment of the present invention, there is provided a computer-readable storage medium that stores a program which, when executed by a computer, causes the computer to perform a process of the image forming apparatus having an image forming part, the process comprising a measuring procedure causing the computer to measure an area in which a recording agent is to be adhered on a recording medium, for each of segmented regions on the recording medium; a computing procedure causing the computer to compute an accumulated area by accumulating the area measured by the measuring procedure for each of the segmented regions with respect to a plurality of recording media; a storing procedure causing the computer to store the accumulated area computed by the computing procedure into a storing part; a rotating procedure causing the computer to rotate an image to be formed on the recording medium using the recording agent if the accumulated value stored in the storing part exceeds a threshold value; and a sending procedure causing the computer to send the image that is rotated by the rotating procedure to the image forming part.

Other objects and further features of the present invention will be apparent from the following detailed description when read in conjunction with the accompanying drawings.

### BRIEF DESCRIPTION OF THE DRAWINGS

FIG. 1 is a diagram for explaining the image ratio;

FIG. 2 is a perspective view illustrating a state where a pressing roller and a fixing belt are used to fix ink on the paper;

FIG. 3 is a diagram for explaining a hardware structure of an example of an image forming apparatus in a first embodiment of the present invention;

FIG. 4 ds a block diagram illustrating a hardware structure of an example of a control part of the image forming apparatus;

FIG. 5 is a block diagram for explaining an example of a functional structure of the control part;

FIG. 6 is a diagram illustrating an example of a screen of an operation panel of the image forming apparatus;

FIG. 7 is a diagram for explaining an example of region information corresponding to medium size and stored in a region storing part;

FIG. 8 is a diagram for explaining an example of regions and sections;

FIG. 9 is a diagram for explaining an example of bit map data;

FIG. 10 is a flow chart for explaining an example of a procedure to count a number of ink adhering sections for each region and to compute an area;

FIG. 11 is a diagram for explaining an example accumulated area for each region stored in an accumulated area storing part;

FIG. 12 is a flow chart for explaining an example of a process to generate an image information signal for forming a rotated image;

FIG. 13 is a block diagram for explaining an example of a functional structure of the control part of the image forming apparatus in a second embodiment of the present invention; and

FIGS. 14A through 14D are diagrams for explaining states in which ink is fixed on a recording medium by a pressing roller and a fixing belt that are examples of wearout parts.

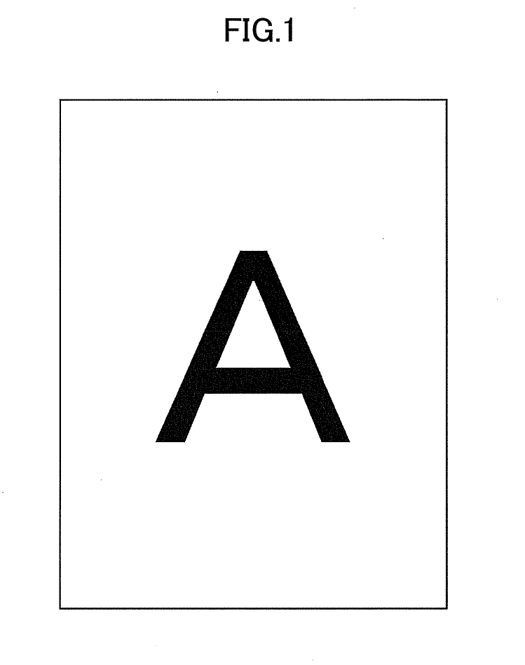

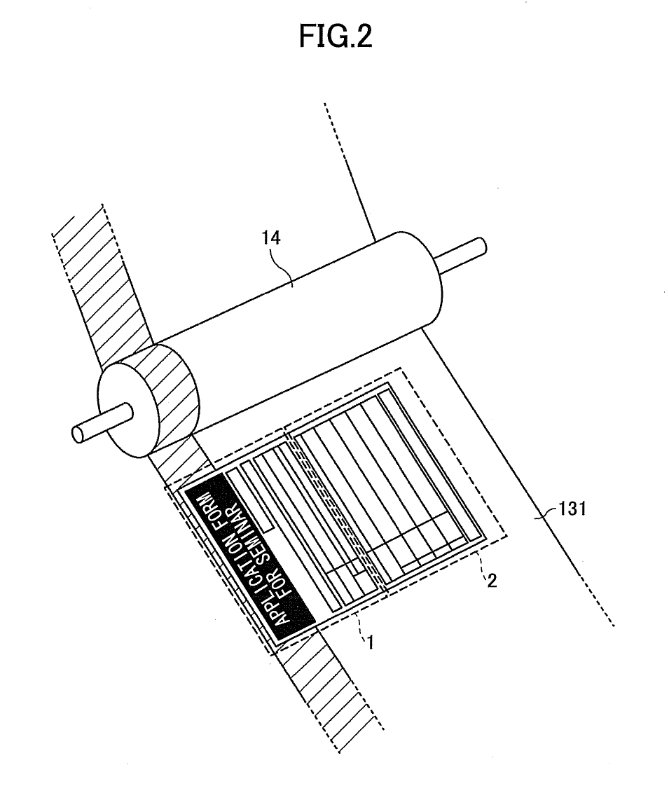

### DESCRIPTION OF THE PREFERRED EMBODIMENTS

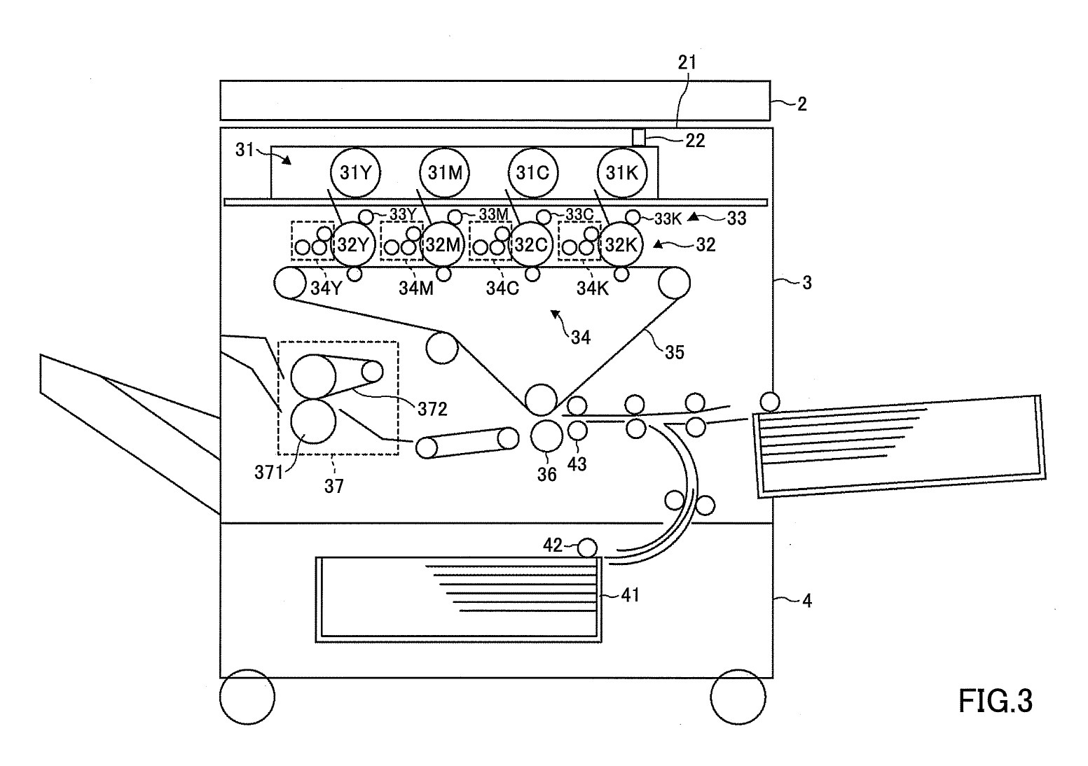

A description will be given of embodiments of the image forming apparatus and the computer-readable storage medium according to the present invention, by referring to FIG. 3 and the subsequent figures.

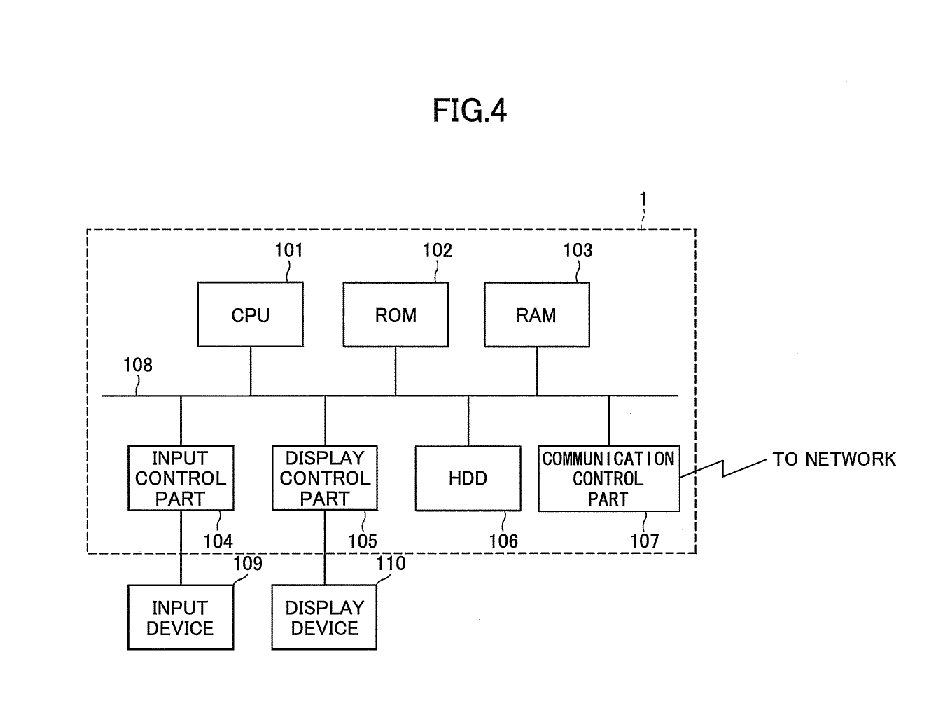

FIG. 3 is a diagram for explaining a hardware structure of an example of an image forming apparatus in a first embodiment of the present invention. In this embodiment, a copying apparatus (or machine) forms an example of the image forming apparatus. The copying apparatus includes a scanner part 2, a printer part 3, and a medium supply part 4 illustrated in FIG. 3, and a control part 1 (not illustrated in FIG. 3) which will be described later in conjunction with FIG. 4.

The scanner part 2 includes a contact glass 21 and a read sensor 22. A document that is to be read is placed on the contact glass 21. The read sensor 22 includes CCDs (Charge Coupled Devices) or the like. When light is irradiated on the document on the contact glass 21, the read sensor 22 converts light reflected from the document into an electrical image information signal, and sends the image information signal to the control part 1.

A description will be given of a hardware structure of the control part 1, by referring to FIG. 4. FIG. 4 is a block diagram illustrating the hardware structure of an example of the control part of the copying apparatus.

The control part 1 illustrated in FIG. 4 includes a CPU (Central Processing Unit) 101, a ROM (Read Only Memory) 102, a RAM (Random Access Memory) 103, an input control part 104, a display control part 105, a HDD (Hard Disk Drive) 106, and a communication control part 107 that are connected via a bus line 108.

The CPU 101 forms an example of a processor or computer which controls the operation of the copying apparatus by executing one or a plurality of programs. The one or plurality of programs, when executed by the CPU 101, cause the CPU 101 to perform one or more processes that realize functions of the copying apparatus by controlling various parts of the copying apparatus. The ROM 102 stores data and programs, including a system start (or boot) program. The RAM 103 stores various data and may be used as a work area by the CPU 101 which executes the programs.

The input control part 104 receives input data, including commands, from an input device 109 which may be formed by an operation panel, for example, and transfers the input data, including commands, to the CPU 101. The display control part 105 displays data, including messages, on a display device 110 which may be formed by the operation panel. In other words, the input device 109 and the display device 110 may be included in a single device, such as a touch-screen operation panel. The HDD 106 stores data in a hard disk which may be formed by a CD-ROM (Compact Disk Read Only Memory), a CD-R (Compact Disk Recordable), a DVD (Digital Versatile Disk), or the like. Of course, the HDD 106 may be replaced by an external storage device that is connected externally to the control part 1.

The communication control part 107 transmits data and commands to and receives data and commands from an external communication equipment or the like via a communication network (not illustrated).

Each program stored in the ROM 102 may be stored in a computer-readable storage medium in the form of a file having an installable format that is installable into the control part 1 or a file having an executable format that is executable by the CPU 101. For example, the computer-readable storage medium may be formed by any suitable recording medium selected from CD-ROMs, CD-Rs, DVDs, and semiconductor memory devices.

Returning to the description of FIG. 3, a description will now be given of the hardware structure of the printer part 3.

The printer part 3 includes a cartridge 31, a photoconductive drum 32, a charging part 33, a developing part 34, an intermediate transfer belt 35, a secondary transfer roller 36, and a fixing part 37.

The cartridge 31 accommodates a recording agent, such as toner and ink. In this example, four cartridges 31Y, 31M, 31C, and 31K are provided. The four cartridges 31Y, 31M, 31C, and 31K respectively accommodate a yellow (Y) recording agent, a magenta (M) recording agent, a cyan (C) recording agent, and a black (K) recording agent.

An outer peripheral surface of the photoconductive drum 32 is uniformly charged by the charging part 33, and an electrostatic latent image is formed on the surface of the photoconductive drum 32 based on the image information signal received from the control part 1. The developing part 34 adheres the ink on the surface of the photoconductive drum 32 formed with the electrostatic latent image, in order to form an image that is visible. In this example, four photoconductive drums 32Y, 32M, 32C, and 32K are provided in correspondence with the yellow, magenta, cyan, and black cartridges 31Y, 31M, 31C, and 31K.

The charging part 33 makes contact with and applies a voltage to the photoconductive drum 32, in order to charge the surface of the photoconductive drum 32. In this example, four charging parts 33Y, 33M, 33C, and 33B are provided in correspondence with the yellow, magenta, cyan, and black ink.

The developing part 34 adheres the ink within the cartridge 31 onto the surface of the photoconductive drum 32, in order to form the image on the surface of the photoconductive drum 32. In this example, four developing parts 34Y, 34M, 34C, and 34K are provided in correspondence with the yellow, magenta, cyan, and black ink.

The intermediate transfer belt 35 is transported while making contact with the photoconductive drum 32, and an image is formed on a surface of the intermediate transfer belt 35. After the image is formed on the surface of the intermediate transfer belt 35, this image is transferred onto a recording medium, such as paper.

The recording medium supplied from the medium supply part 4 is sandwiched between the secondary transfer roller 36 and the intermediate transfer belt 35, and the image formed on the intermediate transfer belt 35 is transferred onto the recording medium. The recording medium after having the image transferred thereon is transported to the fixing part 37.

The fixing part 37 includes a pressing roller 371 and a fixing belt 372. The fixing part 37 fixes the image on the recording medium that is transported from the secondary transfer roller 36. The pressing roller 371 pushes the recording medium between the pressing roller 371 and the fixing belt 372, and applies heat in order to fix the image on the recording medium.

Next, a description will be given of a hardware structure of the medium supply part 4. The medium supply part 4 includes a medium supply tray 41, a medium supply roller 42, and resist rollers 43. The medium supply part 4 supplies the recording medium, such as paper, to the printer part 3.

The medium supply tray 41 accommodates recording media, such as paper. The medium supply roller 42 obtains the recording medium accommodated in the medium supply tray 41, and supplies the recording medium between the resist rollers 43. The resist rollers 43 supply the recording medium, supplied from the medium supply roller 42, between the intermediate transfer belt 35 and the secondary transfer roller 36.

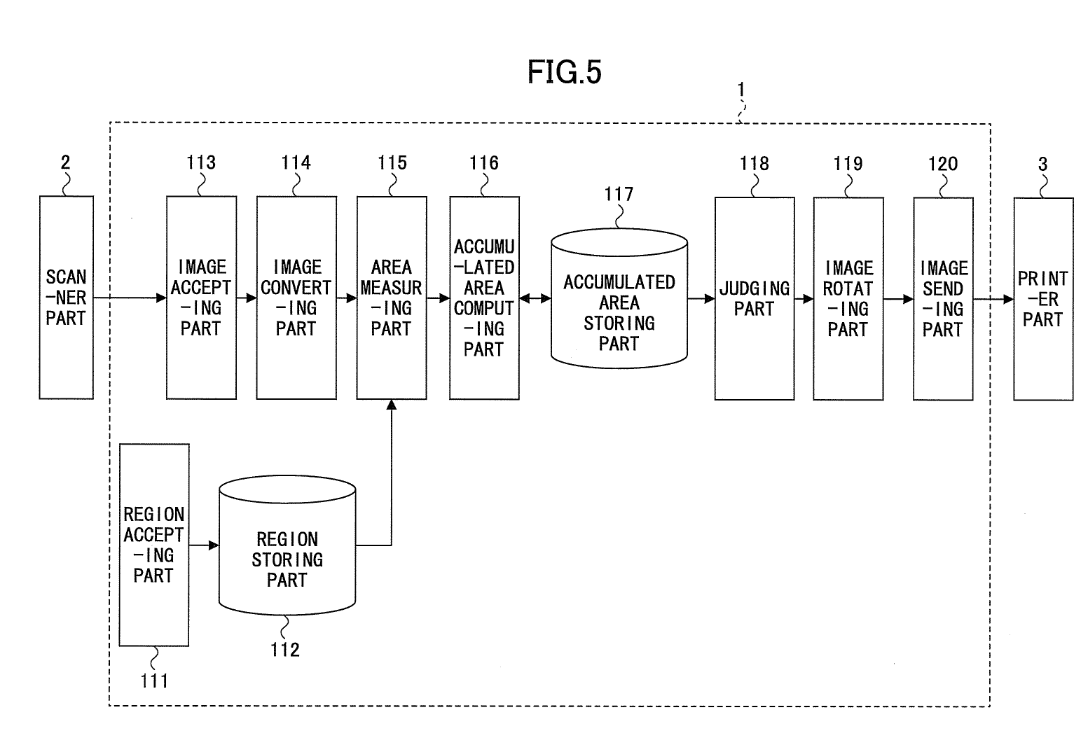

Next, a description will be given of a functional structure of the control part 1, by referring to FIG. 5. FIG. 5 is a block diagram for explaining an example of the functional structure of the control part.

The control part 1 includes a region accepting part 111, a region storing part 112, an image accepting part 113, an image converting part 114, an area measuring part 115, an accumulated area computing part 116, an accumulated area storing part 117, a judging part 118, an image rotating part 119, and an image sending part 120. The one or plurality of programs stored in the ROM 102, when executed by the CPU 101, cause the CPU 101 to perform one or more processes that realize the functions or means of the copying apparatus by controlling various parts of the copying apparatus. Each of the region accepting part 111, the image accepting part 113, the image converting part 114, the area measuring part 115, the accumulated area computing part 116, the image rotating part 119, and the image sending part 120 may be formed by the function or means that is realized responsive to an instruction (or command) from the CPU 101 when the CPU 101 executes the one or plurality of programs. On the other hand, each of the region storing part 112 and the accumulated area storing part 117 may be formed by the RAM 103, the HDD 106 or the like.

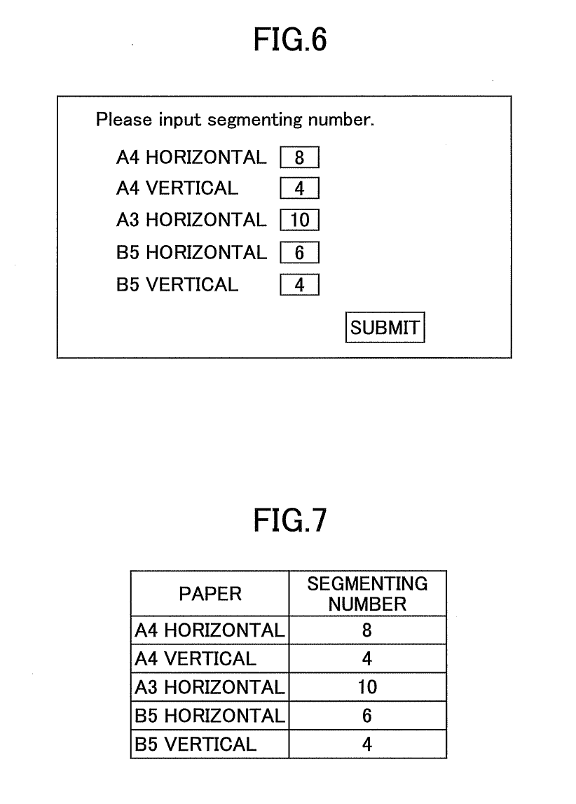

The region accepting part 111 may be formed by the input control part 104, and accepts region information related to a target region. An area of the recording medium to be adhered with the ink is measured within the target region. FIG. 6 is a diagram illustrating an example of a screen of the operation panel of the copying apparatus. More particularly, FIG. 6 illustrates the screen of the input device 109 that is controlled by the input control part 104 of the copying apparatus. When the region information is input by a manager of the copying apparatus from the screen illustrated in FIG. 6 and a submit button SUBMIT is pushed, the region accepting part 111 accepts the region information. For example, when a minimum unit forming the image is regarded as one section, the region information indicates a range from a top left section on the recording medium to a 876th section along a main scan direction of the printer part 3, and a range from the top left section on the recording medium to a 4956th section along a sub scan direction of the printer part 3. The sub scan direction is perpendicular to the main scan direction.

The region storing part 112 stores the region information accepted by the region accepting part 111. FIG. 7 is a diagram for explaining an example of the region information corresponding to medium size and stored in the region storing part 112, that is, a number of segments or divisions (hereinafter also referred to as a segmenting number) for each medium size. When the region information illustrated in FIG. 7 is stored in the region information storing part 112, the area in which the ink is to be adhered is measured for each of the 8 segmented regions of the A4-size paper if the copy is to be made with respect to the A4-size paper oriented horizontally so that the long side of the A4-size paper is parallel to the main scan direction, and is measured for each of the 4 segmented regions of the A4-size paper if the copy is to be made with respect to the A4-size paper oriented vertically so that the short side of the A4-size paper is parallel to the main scan direction. The 8 segmented regions of the A4-size paper oriented horizontally and the 4 segmented regions of the A4-size paper oriented vertically are both arranged along the main scan direction. In the example illustrated in FIG. 7, the area in which the ink is to be adhered is measured for each of the 10 segmented regions of the A3-size paper if the copy is to be made with respect to the A3-size paper oriented horizontally so that the long side of the A3-size paper is parallel to the main scan direction, the area in which the ink is to be adhered is measured for each of the 6 segmented regions of the B5-size paper if the copy is to be made with respect to the B5-size paper oriented horizontally so that the long side of the B5-size paper is parallel to the main scan direction, and the area in which the ink is to be adhered is measured for each of the 4 segmented regions of the B5-size paper if the copy is to be made with respect to the B5-size paper oriented vertically so that the short side of the B5-size paper is parallel to the main scan direction.

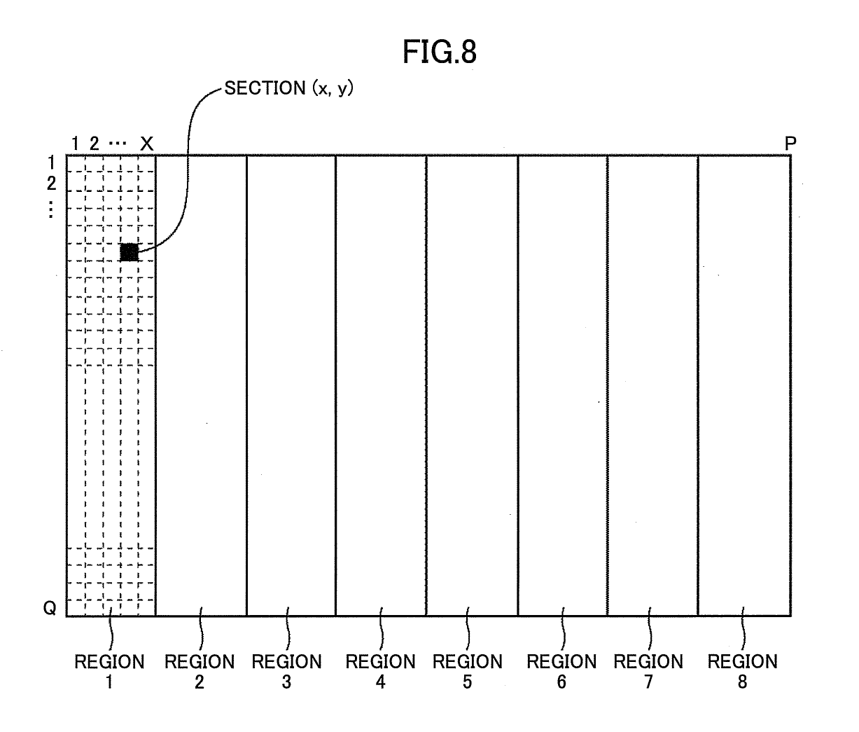

FIG. 8 is a diagram for explaining an example of the regions and the sections. FIG. 8 illustrates an example for a case where the copy is to be made with respect to the A4-size paper oriented horizontally. The A4-size paper is segmented into 8 regions 1 through 8 that are arranged in the main scan direction, and the area in which the ink is to be adhered is measured for each of the regions 1 through 8. Sections within the region 1, for example, are indicated by (or surrounded by) dotted lines, and may be represented by coordinates (x, y).

When the image is formed on the A4-size paper at 600 dpi, 7009 sections exist in the main scan direction and 4956 sections exist in the sub scan direction on the entire A4-size paper. When this A4-size paper is equally segmented into the 8 regions 1 through 8 having the same area, the region 1 includes the first section to the 876th section along the main scan direction, and the first section to the 4956th section along the sub scan direction. The region 2 includes the 877th section to the 1752nd section along the main scan direction, and the first section to the 4956th section along the sub scan direction. Each of the other regions 3 through 8 includes sections that are arranged in the main and sub scan directions in a manner similar to each of the regions 1 and 2. The number of sections in which the ink is to be adhered is counted for each of the regions 1 through 8, with respect to each of the four colors, namely, yellow, magenta, cyan, and black.

The image accepting part 113 accepts the image information signal from the scanner part 2. The image converting part 114 converts the image information signal accepted (or read) by the image accepting part 113 into bit map data. The area measuring part 115 counts the number of sections in which ink is to be adhered on the paper, based on the bit map data obtained by the image converting part 114, with respect to each of the regions stored in the region storing part 112. Further, the area measuring part 115 converts the counted number of sections into the area in which the ink is to be adhered.

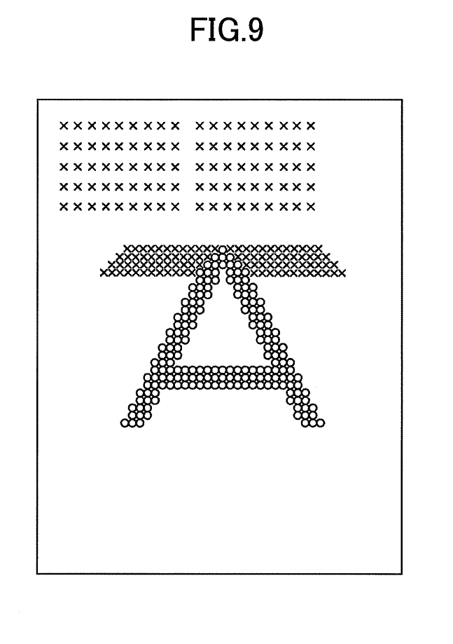

FIG. 9 is a diagram for explaining an example of the bit map data. The bit map data includes information that indicates whether the ink is to be adhered, for each section. In the example illustrated in FIG. 9, a letter “A” is printed on the paper. In FIG. 9, a symbol “o” indicates the section in which the ink is to be adhered to form the letter, and a symbol “x” indicates the section in which no ink is adhered. Hence, the bit map data indicates whether the ink is to be adhered for each of the sections on the paper. The image area ratio is 5% for the example illustrated in FIG. 9.

The accumulated area computing part 116 adds the area measured by the area measuring part 115 to the accumulated area that is stored in the accumulated area storing part 117 for each region, in order to compute a new accumulated area. The accumulated area storing part 117 stores the accumulated area obtained by accumulating the area in which the ink is to be adhered, measured by the area measuring part 115, for each region. When the accumulated area computing part 116 computes the accumulated area, the accumulated area storing part 117 stores the computed accumulated area as the new accumulated area.

The judging part 118 judges whether the accumulated area stored in the accumulated area storing part 117 exceeds a threshold value. When the accumulated area stored in the accumulated area storing part 117 exceeds the threshold value, the image rotating part 119 generates an image information signal for forming a rotated image from the converted image information signal, that is, the bit map data obtained by the image converting part 114. The rotated image may be an inverted image corresponding to a 180°-rotated image of the original image. Alternatively, the rotated image may be a +90°-rotated image of the original image or, a −90°-rotated image of the original image.

The image sending part 120 sends to the printer part 3 an image information signal that is formed by the bit map data obtained by the image converting part 114 if the accumulated area does not exceed the threshold value. On the other hand, the image sending part 120 sends to the printer part 3 an image information signal that is formed by the rotated bit map data obtained by the image rotating part 119 if the accumulated area exceeds the threshold value.

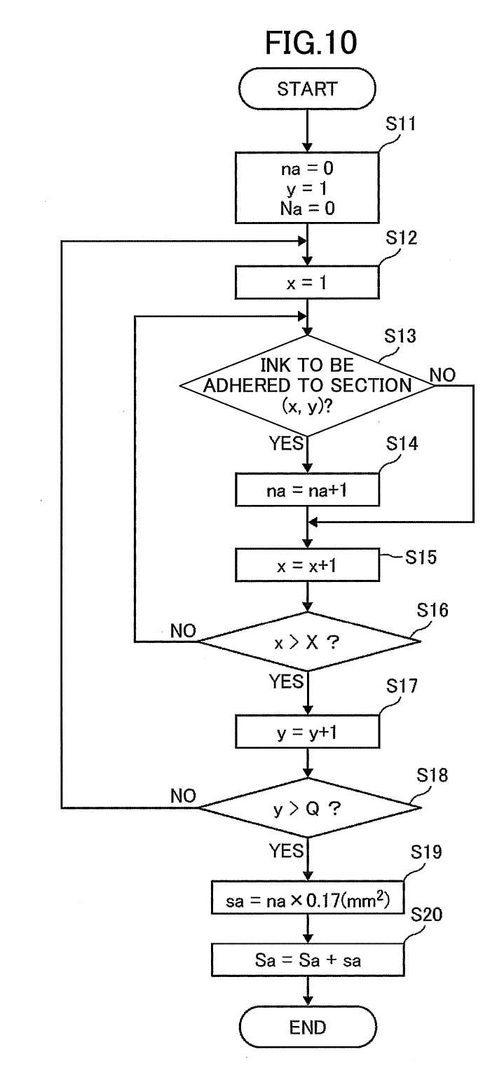

Next, a description will be given of the processes performed by the copying apparatus in this embodiment, by referring to FIGS. 10 through 13.

First, a description will be given of a setting procedure of the control part 1. The setting procedure sets the target region that is the target of the measurement, in order to measure the area in which the ink is to be adhered with respect to a predetermined region for each paper size.

The manager of the copying apparatus inputs the segmenting number of the recording region, as the region information, and the region accepting part 111 accepts the segmenting number. The region storing part 112 stores the region that is equally segmented based on the segmenting number accepted by the region accepting part 111, in correspondence with the paper size.

Next, a description will be given of the operation of the control part 1.

When the operator (or user) of the copying apparatus sets the document on the contact glass 21 of the scanner part 2 and pushes a start switch (not illustrated), light is irradiated on the document set on the contact glass 21. The read sensor 22 converts light reflected from the document into the electrical image information signal, and sends the image information signal to the image accepting part 113 of the control part 1.

The image accepting part 113 accepts the image information signal received from the scanner part 2. The image information signal accepted by the image accepting part 113 is converted into the bit map data by the image converting part 114. When the read image information signal is converted into the bit map data, the area measuring part 115 measures the area in which the ink is to be adhered, based on the bit map data (or converted image information signal). In this embodiment, the number sections in which the ink is to be adhered is counted for each of the four colors, namely, yellow, magenta, cyan, and black, for each region. In addition, the counted number of sections is multiplied by the area per section, for each of the four colors, in order to compute the area in which the ink of the corresponding color is to be adhered.

FIG. 10 is a flow chart for explaining an example of a procedure to count the number of ink adhering sections for each region and to compute the area.

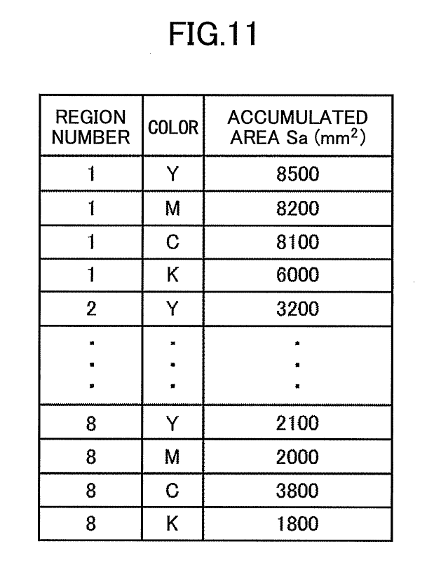

When the number of sections of the recording region on the recording medium along the main scan direction is denoted by P, the number of sections of the recording region on the recording medium along the sub scan direction is denoted by Q, and the segmenting number along the main scan direction is 8 as illustrated in FIG. 8, the number of sections within each region along the main scan direction becomes P/8. In the following description and FIG. 11, P/8 will be denoted by X. On the other hand, the number of sections within each region along the sub scan direction becomes Q because no segmentation is made along the sub scan direction.

Next, a description will be given of the process of the area measuring part 115.

A number “na” of sections in which the ink is to be adhered in a region “a” may be counted by judging whether the ink is to be adhered in a section (x, y). First, a step S11 sets “na” and “y” to na=0 and y=1, and sets an accumulated number of pixels, “Na”, to Na=0. Then, a step S12 sets “x” to x=1, and a step S13 decides (or judges) whether the ink is to be adhered in a section (1, 1). If the decision result in the step S13 is YES, a step S14 sets “na” to na=1, and the process advances to a step S15. On the other hand, if the decision result in the step S13 is NO, the process advances to the step S15 (that is, na=0).

The step S15 increments “x” to x=x+1. Hence, x=2 when the step S15 is carried out for the first time. A step S16 decides whether “x” exceeds the number of sections, “X”, along the main scan direction within the region “a”. That is, the step S16 decides whether x>X. The process returns to the step S13 if the decision result in the step S16 is NO, and this time, the step S13 decides whether the ink is to be adhered in a section (2, 1). Hence, the steps S13 through S16 are repeated to determine whether the ink is to be adhered in sections (4, 1), . . . , (X, 1).

On the other hand, if the decision result in the step S16 is YES, a step S17 increments “y” to y=y+1. A step S18 decides whether y>Q, and the process returns to the step S12 if the decision result in the step S18 is NO. Hence, after the first line along the main scan direction is processed, the steps S12 through S18 are repeated to determine whether the ink is to be adhered in sections (1, 2), (2, 2), . . . , (X, 2) in order to process the second line along the main scan direction. After the second line along the main scan direction is processed, the steps S12 through S18 are repeated to determine whether the ink is to be adhered in sections (1, 3), (2, 3), . . . , (X, 3) in order to process the third line along the main scan direction. The fourth through Qth lines along the main scan direction are processed in a similar manner by repeating the steps S12 through S18.

If the processing up to the section (X, Q) ends and the decision result in the step S18 becomes YES, a step S19 multiplies the area per section, 0.17 mm², to the number of sections, “na”, in order to compute an area “sa” in which the ink is to be adhered. In other words, the step S19 computes sa=nax0.17 (mm²). Then, a step S20 adds the accumulated area “Sa2 stored in the accumulated area storing part 117 to the computed area “sa”, that is, computes Sa=Sa+sa, and the process ends.

The area “sa” is computed in a similar manner for the second and subsequent copies (or printed sheets). Each area “sa” that is computed is added to the accumulated area “Sa” stored in the accumulated area storing part 117, and the accumulated area “Sa” added with the computed area “sa” is stored in the accumulated area storing part 117.

FIG. 11 is a diagram for explaining an example the accumulated area for each region stored in the accumulated area storing part 117. In this example, the copy is made on the A4-size paper that is segmented into 8 regions along the main scan direction, and the area in which the ink is to be adhered is computed for the ink of each color. FIG. 11 illustrates the accumulated area in which the ink is to be adhered for each region, with respect to the ink of each color. For example, the accumulated area “Sa” in which the yellow (Y) ink is to be adhered is 8,500 mm² for the region that is assigned a region number “1”.

The procedure for measuring the area in which the ink is to be adhered is of course not limited to the procedure described above. In addition, although the area is measured for each of the equally segmented regions of the paper in the example described above, the paper area does not necessarily have to be equally segmented. The area in which the ink is to be adhered may be measured for each region depending on the manner or tendency in which the copying apparatus is utilized.

Next, the judging part 118 judges whether the accumulated area stored in the accumulated area storing part 117 exceeds the threshold value, by comparing the accumulated area and the threshold value. If the accumulated area does not exceed the threshold value, the image sending part 120 sends the bit map data obtained by the conversion performed in the image converting part 114 to the printer part 3. On the other hand, if the accumulated area exceeds the threshold value, the image rotating part 119 generates the image information signal for forming the rotated image of the image indicated by the bit map data that is obtained by the conversion performed in the image converting part 114.

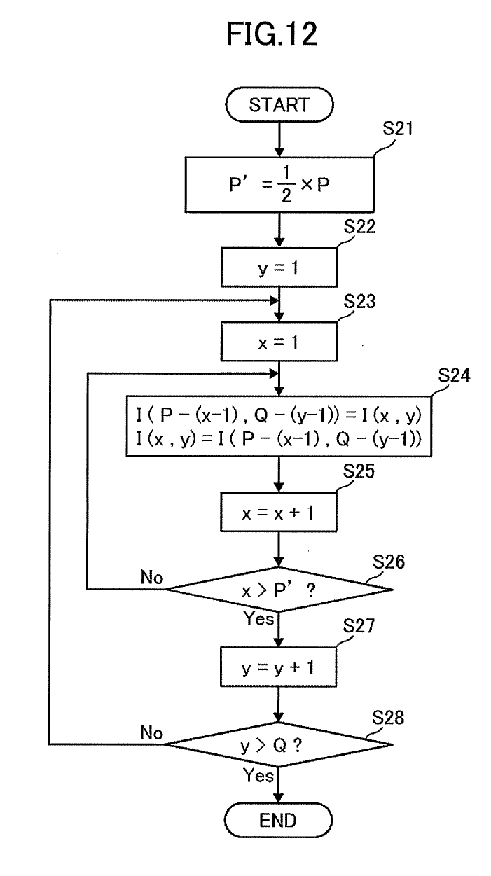

A description will be given of the process of generating the image information signal for forming the rotated image, by referring to FIG. 12. FIG. 12 is a flow chart for explaining an example of the process to generate the image information signal for forming the rotated image. It is assumed for the sake of convenience in the following description that I(x, y) denotes information indicating whether the ink is to be adhered in the section (x, y) when performing the print operation.

I(x, y)=0 when the ink is not to be adhered in the section (x, y), and I(x, y)=x when the ink is to be adhered in the section (x, y). The number of sections along the main scan direction in the recording region on the paper is denoted by P, and the number of sections along the sub scan direction in the recording region of the paper is denoted by Q.

First, in a step S21, the image rotating part 119 computes a value P′ that is ½ the number of sections, P, along the main scan direction. Then, a step S22 sets y to y=1, and a step S23 sets x to x=1. A step S24 transforms information I(P−(x−1), Q−(y−1)) to I(x, y), and transforms the information I(x, y) into the information I(P−(x−1), Q−(y−1)). Hence, when y=1 and x=1, the information I(1, 1) indicating whether the ink is to be adhered in the section (x, y) into the information I(P, Q) indicating whether the ink is to be adhered to a position (P, Q) that is in a point symmetry to a center position of the paper, and the step S24 similarly transforms the information I(P, Q) into the information I(1, 1) of the section in point symmetry to the center position of the paper. Then, a step S25 increments x to x=x+1, that is, to x=2. A step S26 decides whether x is greater than P′ (that is, x>P′). If the decision result in the step S26 is NO, the step S24 transforms the information I(2, 1) into the information I(P−1, Q), and transforms the information I(P−1, Q) into the information I(2, 1). Similarly thereafter, the steps S24 through S26 are repeated to transform the information I(3, 1), I(4, 1), . . . into the information of the section in point symmetry to the center position of the paper.

If the processing of the sections in the first line ends and the decision result in the step S26 becomes YES, a step S27 increments y to y=y+1, that is, y=2. A step S28 decides whether y>Q, and the process returns to the step S23 if the decision result in the step S28 is NO. Hence, steps S24 through S26 are repeated to transform the information I(1, 2), (2, 2), . . . , (x, 2), . . . indicating whether to adhere the ink in the section (1, 2), (2, 2), . . . , (x, 2) into the information I(P, Q−1), I(P−1, Q−1), I(P−(x−1), Q−1), . . . in order to perform the processing of the sections in the second line. The processing of the sections in the third through the Qth line is performed in a similar manner by repeating the steps S23 through S28.

The process ends if the decision result in the step S28 becomes YES. After the processing of the sections in the Qth line ends, the information I(x, y) that is obtained is formed bit map data (or image information signal) representing the rotated image of the original image. The image sending part 120 sends the image information signal of the rotated image, that is generated by the image rotating part 119, to the printer part 3.

Next, a description will be given of the process of forming the image by the printer part 3 and the medium supply part 4, based on the image information signal received from the image sending part 120.

First, the charging part 33 makes contact with and applies the voltage to the photoconductive drum 32, in order to charge the surface of the photoconductive drum 32. An exposure device (not illustrated) emits a laser beam onto the surface of the photoconductive drum 32 based on the image information signal received from the control part 1, and forms the electrostatic latent image on the surface of the photoconductive drum 32. The developing part 34 adheres the ink from the cartridge 31 on the surface of the photoconductive drum 32 carrying the electrostatic latent image, in order to develop the electrostatic latent image and form the visible image on the surface of the photoconductive drum 32.

Then, the intermediate transfer belt 35 is transported while making contact with the surface of the photoconductive drum 32. As a result, the visible image formed on the surface of the photoconductive drum 32 is transferred onto the intermediate transfer belt 35.

On the other hand, the medium supply roller 42 obtains the paper accommodated in the medium supply tray 41, and supplies the paper between the resist rollers 43. The resist rollers 43 supply the paper, supplied from the medium supply roller 42, between the intermediate transfer belt 35 and the secondary transfer roller 36. The paper that is inserted in this manner is sandwiched between the intermediate transfer belt 35 and the secondary transfer roller 36 and transported. Hence, the image on the intermediate transfer belt 35 is transferred onto the paper as the paper is transported between the intermediate transfer belt 35 and the secondary transfer roller 36. Thereafter, the pressing roller 371 pushes the paper between the pressing roller 371 and the fixing belt 372, and applies heat in order to fix the image on the paper.

Therefore, the uneven wear of the wearout parts may be prevented and the serviceable life of each wearout part may be extended by rotating the image that is to be printed, based on the area in which the ink is to be adhered on the paper. This rotating of the image that is to be printed may invert (or reverse) the image that is to be printed, so that the inverted image corresponds to a 180°-rotated image of the image that is to be printed. Of course, the rotating of the image that is to be printed may rotate the image that is to be printed by +90° or −90°.

Next, a description will be given of a second embodiment of the present invention. In this second embodiment, unlike the first embodiment described above, the extent of the wear of the wearout part is detected before or after the accumulated area stored in the accumulated area storing part 117 exceeds the threshold value, in order to judge whether the image is to be rotated.

The hardware structure of the image forming apparatus (or copying apparatus) in this second embodiment may be the same as that of the first embodiment illustrated in FIGS. 3 and 4, and a description and illustration thereof will be omitted.

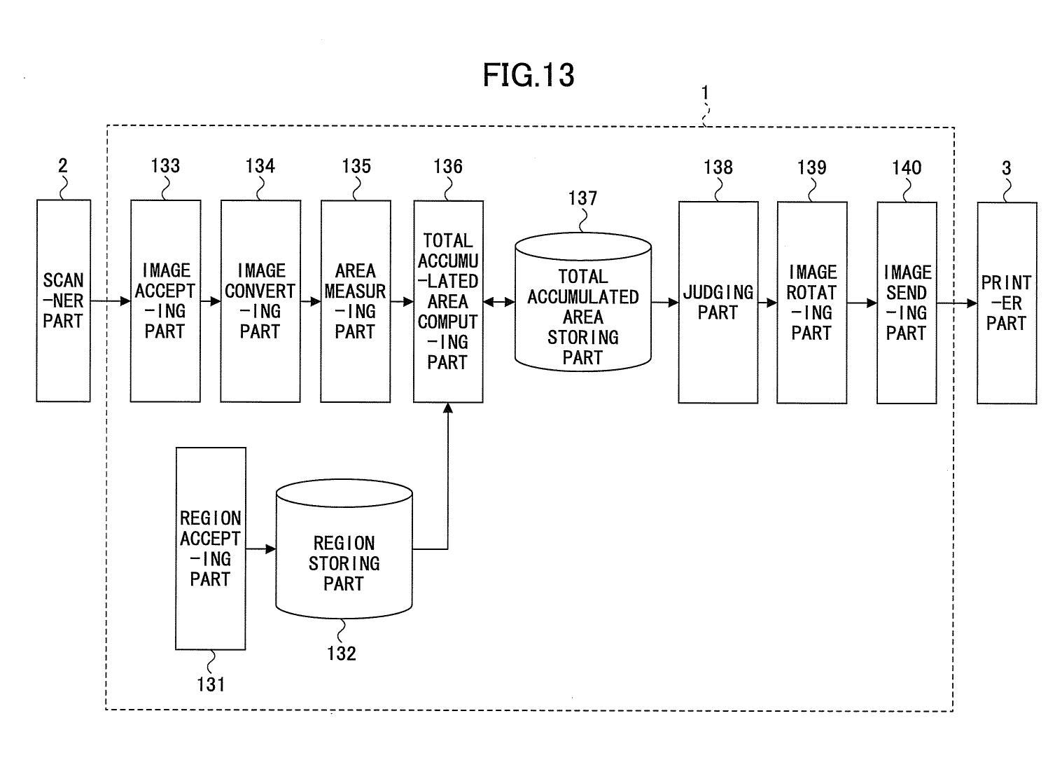

FIG. 13 is a block diagram for explaining an example of a functional structure of the control part 1 in the second embodiment of the present invention.

The control part 1 illustrated in FIG. 13 includes a region accepting part 131, a region storing part 132, an image accepting part 133, an image converting part 134, an area measuring part 135, a total accumulated area computing part 136, a total accumulated area storing part 137, a judging part 138, an image rotating part 139, and an image sending part 140.

The region accepting part 131, the region storing part 132, the image accepting part 133, the image converting part 134, the area measuring part 135, the image rotating part 139, and the image sending part 140 operate in the same manner as the region accepting part 111, the region storing part 112, the image accepting part 113, the image converting part 114, the area measuring part 115, the image rotating part 119, and the image sending part 120 of the first embodiment illustrated in FIG. 5, and a description thereof will be omitted.

The total accumulated area computing part 136 computes the total accumulated area by accumulating the total of the area of a predetermined region and the area of a region positioned (or located) symmetrically thereto with respect to a line segment extending in the sub scan direction and equally segmenting the paper, for the area measured by the area measuring part for each region.

For example, if the entire paper is equally segmented into the 8 regions 1 through 8 as illustrated in FIG. 8 and the accumulated area is to be computed for each region, a total accumulated area is obtained by computing the accumulation of the total of the areas of the mutually symmetrical regions 1 and 8. In addition, a total accumulated area is obtained by computing the accumulation of the total of the areas of the mutually symmetrical regions 2 and 7, a total accumulated area is obtained by computing the accumulation of the total of the areas of the mutually symmetrical regions 3 and 6, and a total accumulated area is obtained by computing the accumulation of the total of the areas of the mutually symmetrical regions 4 and 5.

The total accumulated area storing part 137 stores the total accumulated area that is computed by the total accumulated area computing part 136. The judging part 138 judges whether one of the total accumulated areas stored in the total accumulated area computing part 136 exceeds a threshold value that is preset.

Next, a description will be given of the processes performed by the copying apparatus in this embodiment.

The region accepting part 131 accepts the segmenting number input by the manager. The region storing part 132 stores the regions that are equally segmented based on the segmenting number that is accepted by the region accepting part 131, in correspondence with the paper size. These processes are the same as those of the first embodiment described above, and a detailed description thereof will be omitted.

The scanner part 2 sends the image information signal related to the read document to the image accepting part 133 of the control part 1. The image information signal accepted by the image accepting part 133 is converted into the bit map data by the image converting part 134. The area measuring part 135 measures the area for each region, based on the bit map data that is obtained by the conversion performed in the image converting part 134. These processes are also the same as those of the first embodiment described above, and a detailed description thereof will be omitted.

When the area measuring part 135 measures the area for each region, the total accumulated area computing part 136 adds the total of the area of the predetermined region and the area of the region positioned symmetrically thereto with respect to the line segment extending in the sub scan direction and equally segmenting the paper, to the total accumulated area corresponding to the two mutually symmetrical region stored in the total accumulated area storing part 137, in order to compute a new total accumulated area. The total accumulated area storing part 137 stores the new total accumulated area that is computed by the total accumulated area computing part 136.

Next, the judging part 138 judges whether the total accumulated area exceeds the threshold value. If the total accumulated area does not exceed the threshold value, the image sending part 140 sends the bit map data (or image information signal) that is obtained by the conversion performed in the image converting part 134 to the printer part 3. On the other hand, if the total accumulated area exceeds the threshold value, the judging part 138 sends the bit map data (or image information signal) that is obtained by the conversion performed in the image converting part 134 to the image rotating part 139. The process performed in the image rotating part 139 in response to the bit map data from the judging part 138 is the same as that performed by the image rotating part 119 of the first embodiment, and a description thereof will be omitted. When the process performed in the image rotating part 139 ends, the image sending part 140 sends the image information signal of the rotated image to the printer part 3.

The process of printing the image in the printer part 3 in response to the image information signal received from the image sending part 140 is the same as that of the first embodiment, and a description thereof will be omitted.

Accordingly, by comparing the area of the predetermined region and the area of the region positioned symmetrically thereto with respect to the line segment extending in the sub scan direction and equally segmenting the paper, in order to judge whether the image is to be rotated, the extent of wear of the wearout part before or after the image rotation may be taken into consideration. For this reason, the serviceable life of the wearout part may be extended, and the wearout part may be used for a relatively long time compared to the conventional apparatus that does not distribute the wear of the wearout part or perform the image rotation.

In this second embodiment, the threshold value may be set by the manager who manages the copying apparatus. However, the threshold value may be determined by taking into consideration the total accumulated area, and the area in which the ink is to be adhered for a case where a reference number of copies, determined by the manufacturer of the copying machine and used as a reference to determine the replacement timing of the wearout part, is printed at a reference ink adhering ratio. For example, if the reference determined by the manufacturer is such that the photoconductive drum 32 may print 10,000 copies for a case where the ink is adhered on 5% of the entire paper area, and the total accumulated area is measured for each of the 8 segmented regions on the paper, the threshold value may be set to [34,800,000 (sections)×5(%)×0.17 (mm²)]/8 which is approximately 36,980 mm².

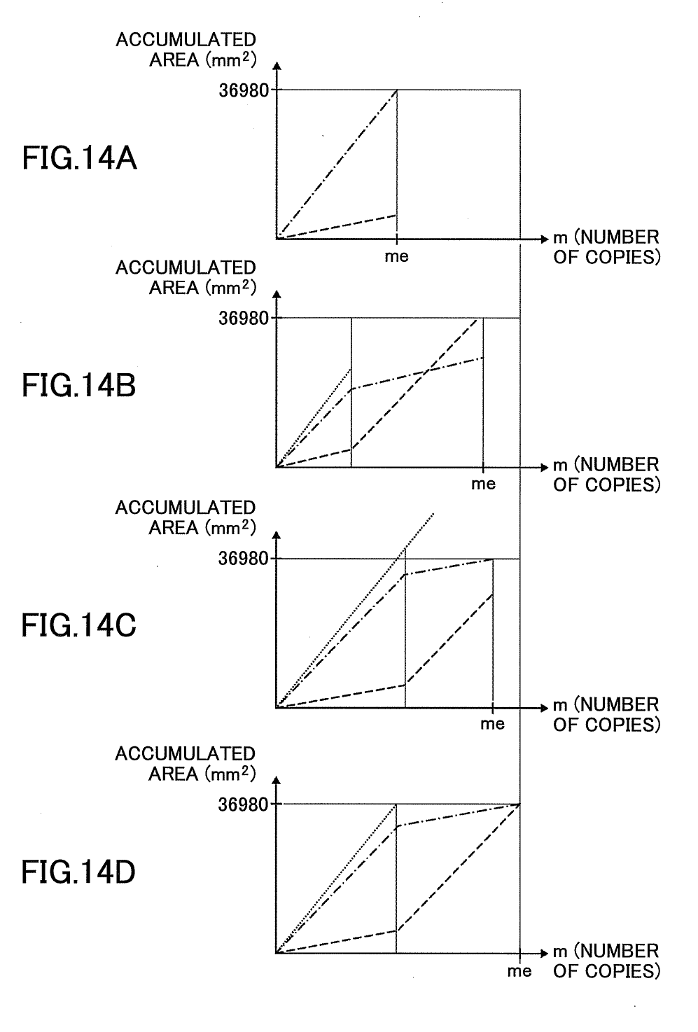

FIGS. 14A through 14D are diagrams for explaining states in which the ink is fixed on the paper by the pressing roller 371 and the fixing belt 372 that are examples of wearout parts. FIGS. 14A through 14D illustrate graphs indicating changes in the accumulated area in which the ink is to be adhered with respect to the number of copies printed, when the same image is printed on a relatively large number of copies. Each of FIGS. 14A through 14D indicate changes in the accumulated area of the region 1 denoted by a one-dot chain line, the accumulated area of the region 8 denoted by a coarse dotted line, and the total accumulated area of the accumulated area of the region 1 and the accumulated area of the region 8 denoted by a fine dotted line. In FIGS. 14A through 14D, the ordinate indicates the accumulated area (mm²), and the abscissa indicates “m” which is the number of copies (or printed sheets) made. In addition, “me” indicates the number of copies that may be printed before the wearout part is to be replaced.

FIG. 14A indicates the change in the area in which the ink is to be adhered when the image rotation process is not performed. FIG. 14B indicates the change in the area in which the ink is to be adhered when the printing is performed by inverting the image (that is, rotating the image by 180°) after the total of the area in which the ink is to be adhered in the region 1 and the area in which the ink is to be adhered in the region 8 exceeds the threshold value. FIG. 14C indicates the change in the area in which the ink is to be adhered when the printing is performed by inverting the image before the total of the area in which the ink is to be adhered in the region 1 and the area in which the ink is to be adhered in the region 8 exceeds the threshold value. FIG. 14D indicates the change in the area in which the ink is to be adhered when the printing is performed by inverting the image when the total of the area in which the ink is to be adhered in the region 1 and the area in which the ink is to be adhered in the region 8 becomes equal to the threshold value.

The number of copies that may be printed before the wearout part is to be replaced, “me”, is smallest for the case illustrated in FIG. 14A. On the other hand, the number of copies that may be printed before the wearout part is to be replaced, “me”, is considerably larger for the cases illustrated in FIGS. 14B, 14C, and 14D when compared to the case illustrated in FIG. 14A, and “me” is largest for the case illustrated in FIG. 14D.

In each of the first and second embodiments described above, the area in which the ink is to be adhered is measured for the case where the paper document is to be copied. However, the area in which the ink is to be adhered may be measured for the case where the print function is used to print images on the paper.

For example, electronic data created (or generated) in a personal computer or the like may be converted into a document written in PDL (Page Description Language) by a printer driver, for example, and sent to the image forming apparatus. In the image forming apparatus, the image converting part 114 or 134 described above may convert the document image information signal written in PDL into bit map data. Hence, the area measuring part 115 or 135 may measure the area in which the ink is to be adhered for each region on the paper, and the process may thereafter be performed in a manner similar to the first or second embodiment described above.

Further, the present invention is not limited to these embodiments, but various variations and modifications may be made without departing from the scope of the present invention.

What is claimed is:

1. An image forming apparatus comprising:
a measuring part configured to measure an area in which a recording agent is to be adhered on a recording medium, for each of segmented regions on the recording medium;
a computing part configured to compute an accumulated area by accumulating the area measured by the measuring part for each of the segmented regions with respect to a plurality of recording media;
a storing part configured to store the accumulated area computed by the computing part;
a rotating part configured to rotate an image to be formed on the recording medium using the recording agent if the accumulated value stored in the storing part exceeds a threshold value; and
an image forming part configured to form on the recording medium the image that is rotated by the rotating part.

2. The image forming apparatus as claimed in claim 1, wherein the segmented regions on the recording medium are arranged in a main scan direction of the image forming part.

3. The image forming apparatus as claimed in claim 1, wherein the segmented regions on the recording medium have the same area.

4. The image forming apparatus as claimed in claim 1, wherein the recording agent is toner or ink.

5. The image forming apparatus as claimed in claim 1, wherein the rotating part obtains a 180°-rotated image of the image to be formed on the recording medium.

6. The image forming apparatus as claimed in claim 1, wherein the rotating part obtains a +90°-rotated image of the image to be formed on the recording medium or, a −90°-rotated image of the image to be formed on the recording medium.

7. An image forming apparatus comprising:
a measuring part configured to measure an area in which a recording agent is to be adhered on a recording medium, for each of segmented regions on the recording medium;
a first computing part configured to compute an accumulated area by accumulating the area measured by the measuring part for each of the segmented regions with respect to a plurality of recording media;
a second computing part configured to compute a total accumulated area by accumulating the area of a predetermined segmented region and the area of a segmented region positioned symmetrically thereto with respect to a line segment extending in a sub scan direction, for the area measured by the measuring part for each of the segmented regions;
a storing part configured to store the total accumulated area computed by the second computing part for each of the segmented regions;
a rotating part configured to rotate an image to be formed on the recording medium using the recording agent if the total accumulated value stored in the storing part exceeds a threshold value; and
an image forming part configured to form on the recording medium the image that is rotated by the rotating part by scanning in a main scan direction and the sub scan direction perpendicular to the main scan direction.

8. The image forming apparatus as claimed in claim 7, wherein the segmented regions on the recording medium are arranged in a main scan direction of the image forming part.

9. The image forming apparatus as claimed in claim 7, wherein the segmented regions on the recording medium have the same area.

10. The image forming apparatus as claimed in claim 7, wherein the recording agent is toner or ink.

11. The image forming apparatus as claimed in claim 7, wherein the rotating part obtains a 180°-rotated image of the image to be formed on the recording medium.

12. The image forming apparatus as claimed in claim 7, wherein the rotating part obtains a +90°-rotated image of the image to be formed on the recording medium or, a −90°-rotated image of the image to be formed on the recording medium.

13. A computer-readable storage medium that stores a program which, when executed by a computer, causes the computer to perform a process of the image forming apparatus having an image forming part, the process comprising:
a measuring procedure causing the computer to measure an area in which a recording agent is to be adhered on a recording medium, for each of segmented regions on the recording medium;
a first computing procedure causing the computer to compute an accumulated area by accumulating the area measured by the measuring procedure for each of the segmented regions with respect to a plurality of recording media;
a storing procedure causing the computer to store the accumulated area computed by the first computing procedure into a storing part;
a rotating procedure causing the computer to rotate an image to be formed on the recording medium using the recording agent if the accumulated value stored in the storing part exceeds a threshold value; and
a sending procedure causing the computer to send the image that is rotated by the rotating procedure to the image forming part.

14. The computer-readable storage medium as claimed in claim 13, wherein the segmented regions on the recording medium are arranged in a main scan direction of the image forming part.

15. The computer-readable storage medium as claimed in claim 13, wherein the segmented regions on the recording medium have the same area.

16. The computer-readable storage medium as claimed in claim 13, wherein the recording agent is toner or ink.

17. The computer-readable storage medium as claimed in claim 13, wherein the rotating procedure causes the computer to obtain a 180°-rotated image of the image to be formed on the recording medium.

18. The computer-readable storage medium as claimed in claim 13, wherein the rotating procedure causes the computer to obtain a +90°-rotated image of the image to be formed on the recording medium or, a −90°-rotated image of the image to be formed on the recording medium.

19. The computer-readable storage medium as claimed in claim 13, wherein the process further comprises:
a second computing procedure causing the computer to compute a total accumulated area by accumulating the area of a predetermined segmented region and the area of a segmented region positioned symmetrically thereto with respect to a line segment extending in a sub scan direction of the image forming part, for the area measured by the measuring part for each of the segmented regions,
wherein the storing procedure causes the computer to store the total accumulated area computed by the second computing procedure for each of the segmented regions, and the rotating procedure causes the computer to rotate the image to be formed on the recording medium using the recording agent if the total accumulated value stored in the storing part exceeds a threshold value.
